(19) United States
(12) Patent Application Publication
(10) Pub. No.: US 2011/0223574 A1
(43) Pub. Date: Sep. 15, 2011

(54) Directed Collaboration Platform for Online Virtual Coaching and Training

(76) Inventors: Benjamin F. CRAWFORD, Kentfield, CA (US); Sean Carew, Corte Madera, CA (US); Gregg W. Crawford, San Rafael, CA (US)

(21) Appl. No.: 13/048,664

(22) Filed: Mar. 15, 2011

Related U.S. Application Data
(60) Provisional application No. 61/314,026, filed on Mar. 15, 2010.

(51) Int. Cl. G09B 5/00

(52) U.S. Cl. 434/322

(57) ABSTRACT

A directed collaboration virtual coach includes a repository of participant and coach profile information, enrollment records, activity records, and reports. A course campaign manager governs communication between participants, coaches, and a virtual coach. The virtual coach works alongside assigned human coaches to assist participants by auto-scaling involvement and direct contact with participants to complement optional human coaching activity and contact on a per assignment basis. A learning content management system contains online course materials and extended participant and coach profiles, collects participant activity, and provides usage reports. Courses comprise a sequence of prescribed assignments that are executed to achieve learning objectives and are organized into participant campaigns and coach campaigns. Each campaign comprises a collection of sequenced dynamic messages, including any of announcements, assignments, advices, and course materials.

### CROSS REFERENCE TO RELATED APPLICATIONS

This application claims priority to U.S. provisional patent application Ser. No. 61/314,026, filed Mar. 15, 2010, which application is incorporated herein in its entirety by this reference thereto.

### BACKGROUND OF THE INVENTION

1. Technical Field

The invention relates to an online, web-enabled system for automating human coaching, advantageous to content delivery and instructional reinforcement; which supports managers in the more efficient execution of critical job tasks; and which streamlines the dissemination and use of critical organizational content for use at work.

2. Description of the Background Art

Presently organizations depend on their managers to work with their teams to ensure that desired performance occurs. This typically involves:
Dissemination of information (“content”) to managers with the expectation that it will be absorbed and used by the managers and their team members. Content can include training programs, information on products, announcements of new company policies, etc.
Coaching of employees by managers to encourage their successful use of the distributed content at work to achieve desired organizational results.
Tracking whether managers have in fact disseminated and reinforced content with their subordinates.
Measuring the fact that employees have in fact used content to improve work results.

Unfortunately, in most organizations these critical elements of organizational management seldom occur, or occur with large variations in quality of performance.

This occurs for a variety of reasons:
Heavy manager workload: Managers are busy and overworked, and pay only sporadic attention to the task of reinforcing new content disseminated to their teams and coaching to prompt its effective use.
Low skill level: Managers are often unskilled in effective ways to initiate, conduct, and follow up on coaching opportunities with their people. As a result, coaching meetings happen sporadically (if at all), and with uneven levels of quality and result.
Low motivation to coach: Relative to other tasks, managers have relatively less motivation to coach and reinforce dissemination/use of content. For example, many sales managers are compensated based on financial performance of their teams, and are therefore motivated to intercede directly to help make sales, rather than coaching their sales professionals how to do it themselves using information or skills shared by management.
Poor follow up: Systems for following up to ensure that coaching around key content occurs are weak, which encourages managers to under-coach and spend their limited time focused on areas where senior management does follow, e.g. in areas related to achievement of financial goals.

At the same time, corporations employ a variety of methods to disseminate content and attempt to ensure its successful use by employees, including:
Live and online training programs;
Written documentation, often sent via email and attachments;
Voicemail;
Intranet portals;
All-company, all-division, or all-team meetings (in person or online); and
Annual “kick off” conferences with speakers and presentations.

Methods such as these are expensive and often fail to achieve their goals related to organizational performance improvement. The reasons for this include:
Information overload: So much information is presented at one time that managers and their teams have trouble focusing on and using the most critical content.
Poor content design: The quality, design, and structure of the content disseminated is ineffective, hard to absorb, too dense for easy consumption, or confusing.
Lack of feedback systems: Once content is disseminated, it is often not followed up upon to ensure that it has been absorbed, coached to, and used on the job.
Lack of results tracking capability: Once content is disseminated, organizations have no way to collect information about results achieved through use of content.

It would be advantageous to provide technology that addresses the critical organizational need for content dissemination.

### SUMMARY OF THE INVENTION

A presently preferred embodiment of the invention provides a directed collaboration platform for online virtual coaching and training (the “directed collaboration platform”) that addresses the critical organizational need for content dissemination with a technology that:
Provides virtual coaching to allow the manager's coaching function to occur even if the manager lacks the time or motivation to perform this function personally.
Professionalizes and improves the quality of content distributed through managers to their teams, ensuring more consistent absorption and use of that content at work.
Provides additional motivation for managers to coach by:
   1) Providing high quality media-supported content that encourages better coaching meetings with staff; and
   2) Prompting the managers with reminders of the importance of coaching on a regular basis.
Collects evidence for corporate management that content is being reinforced at work by employees, and has been used effectively to achieve valued organizational results.
Provides data to corporate management on the use of the system to assist in gauging the return on investment from the directed collaboration platform.
Improves overall efficiency of the process of disseminating content, ensuring coaching occurs around that content, and tracking use of content on the job (when compared to current methods).

### BRIEF DESCRIPTION OF THE DRAWINGS

FIG. 1 is a block schematic diagram showing a directed collaboration virtual coach platform according to the invention;

FIG. 2 is a block schematic diagram showing registration access control (RACS) for a directed collaboration virtual coach according to the invention;

FIG. 3 is a block schematic diagram showing course campaign manager (CCM) details for a directed collaboration virtual coach platform according to the invention;

FIG. 4 is a block schematic diagram showing an email assignment in a directed collaboration virtual coach platform according to the invention;

FIG. 5 is a block schematic diagram showing a learning content management system for a directed collaboration virtual coach platform according to the invention;

FIG. 6 is a block schematic diagram showing an example case having minimal virtual coach involvement according to the invention;

FIG. 7 is a block schematic diagram showing an example case having shared coach reinforcement for a human coach and automated virtual coach according to the invention; and

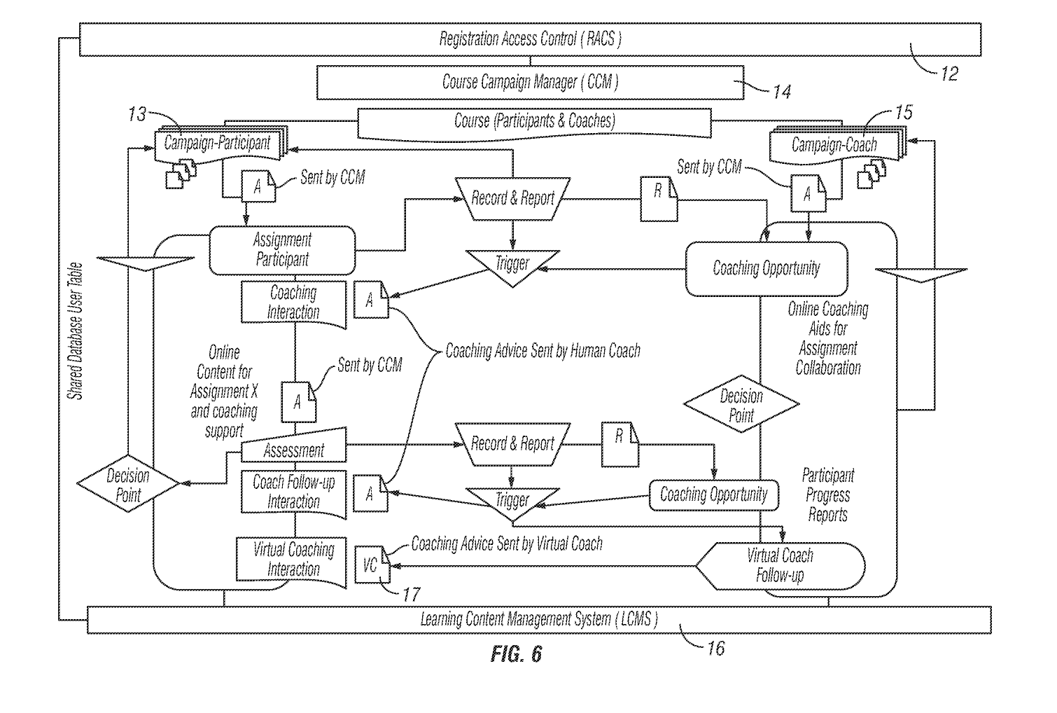

FIG. 6 is a block schematic diagram showing an example case having a total virtual coach-driven implementation according to the invention.

### DETAILED DESCRIPTION OF THE INVENTION

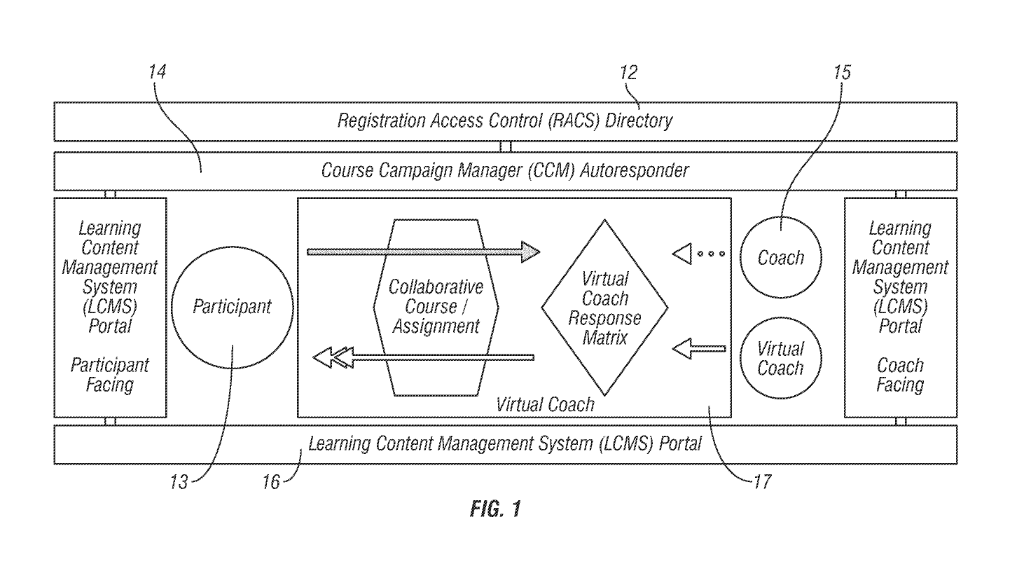

FIG. 1 is a block schematic diagram showing a directed collaboration virtual coach platform according to the invention. A presently preferred embodiment of the directed collaboration virtual coach delivery platform comprises three components:

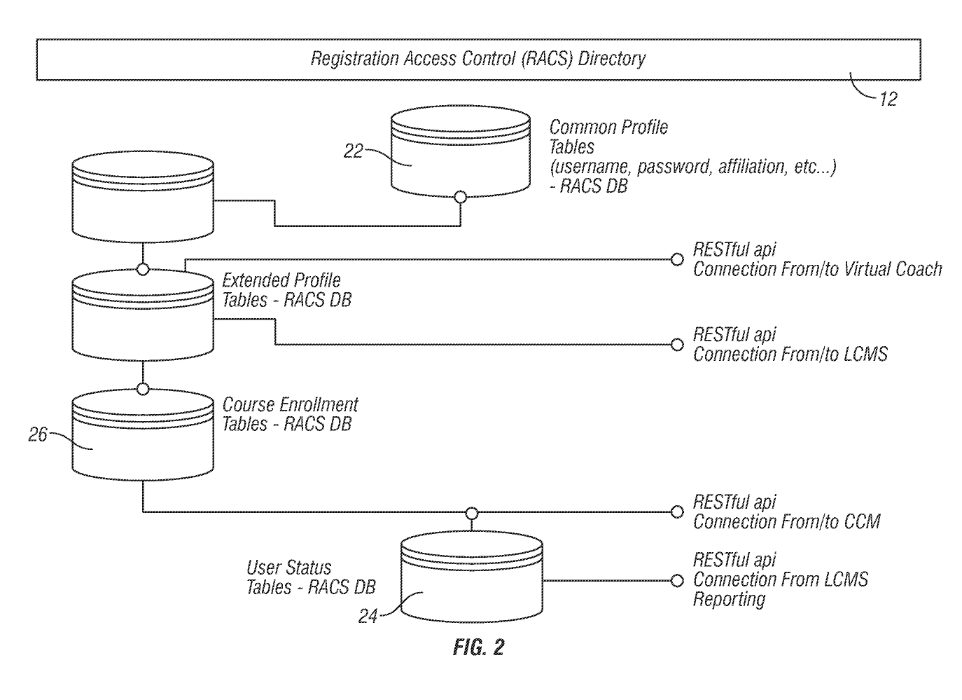

Registration Access Control (RAGS) 12 (see FIG. 2) is the repository of participant and coach profile information 22, enrollment records 26, activity records and reports 24. The RACS component communicates with the other system components through the RESTful API.

The Course Campaign Manager (CCM) 14 governs total communication between participants 13, coaches 15, and the Virtual Coach 17. The CCM uses POP, SMTP, RSS, and XML to communicate with participants, coaches, and the other components of the platform.

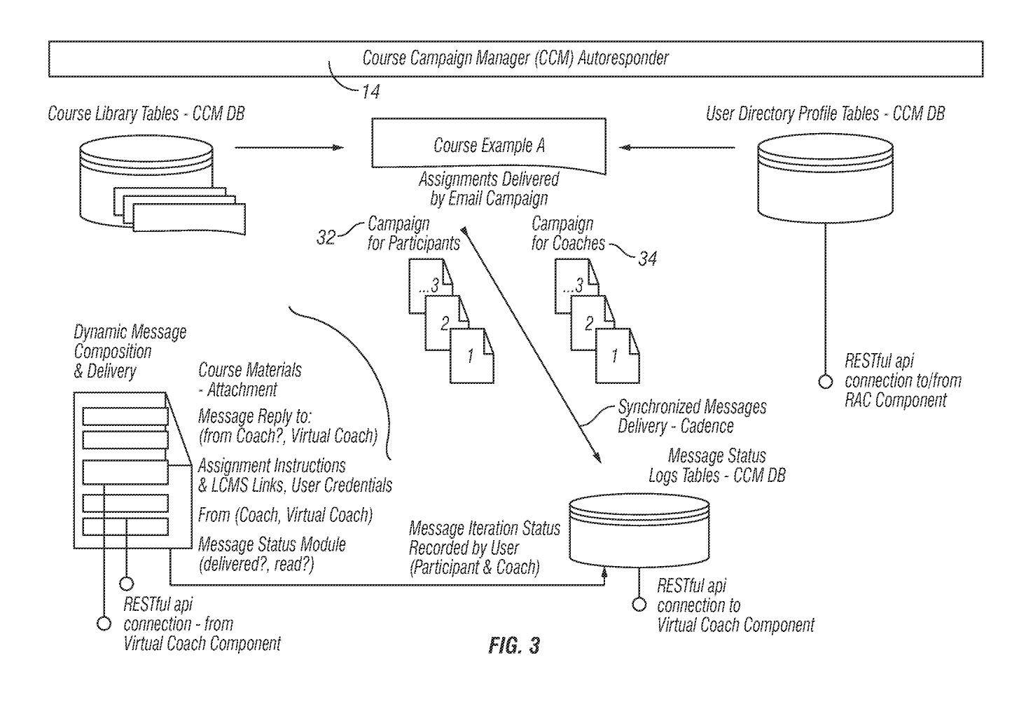

Courses are organized into Participant Campaigns 32 and Coach Campaigns 34 (see FIG. 3). Each campaign is a collection of sequenced dynamic messages, such as announcements, assignments, advices, course materials, etc. Participant profiles are shared with the Registration Access Control (RACS).

The Learning Content Management System (LCMS) 16 contains online course materials and extended participant and coach profiles, collects participant activity, and provides usage reports. The LCMS operates in a secure password authenticated environment.

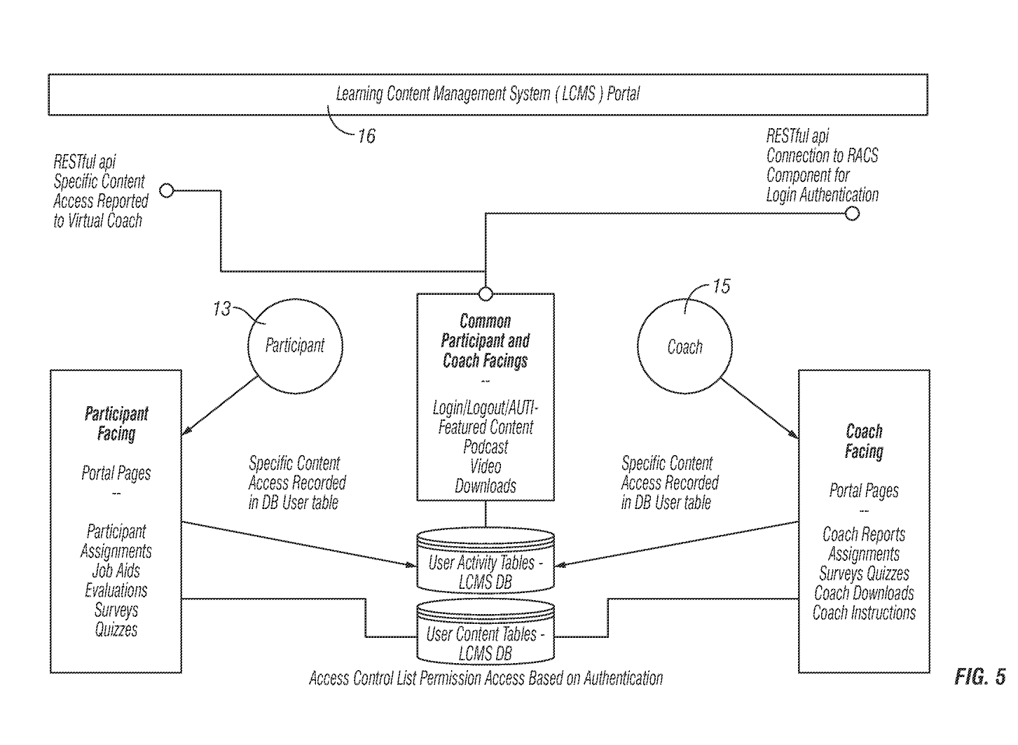

Participant credentials and profile are shared with the Registration Access Control (RACS) (see FIG. 5).

Course Campaign Manager (CCM), Learning Content Management System (LCMS), Registration Access Control System (RACS): Each component is loosely coupled to the other in a federated, protocol driven configuration and communicates through common protocols listed above and the RESTful API.

All activity is broadly organized according to a Collaborative Course Architecture. A course is a sequence of prescribed assignments that are executed to achieve learning objectives. Typical e-learning course design anticipates the roles of an instructor or instructional agent and a participant. Collaborative course designs feature the role of a third party coach/manager. Course assignments for participants have a corresponding and complementary assignment for the matched third party coach, where an interaction between parties is an outcome required to complete the assignment. As a simple example: Participant A watches a video and is required to answer a series of questions and then speak to Coach B to discuss. During this interaction, Coach B is assigned to ask Participant A additional related questions, to discuss the answer, and to collaborate on ways to apply what has been related.

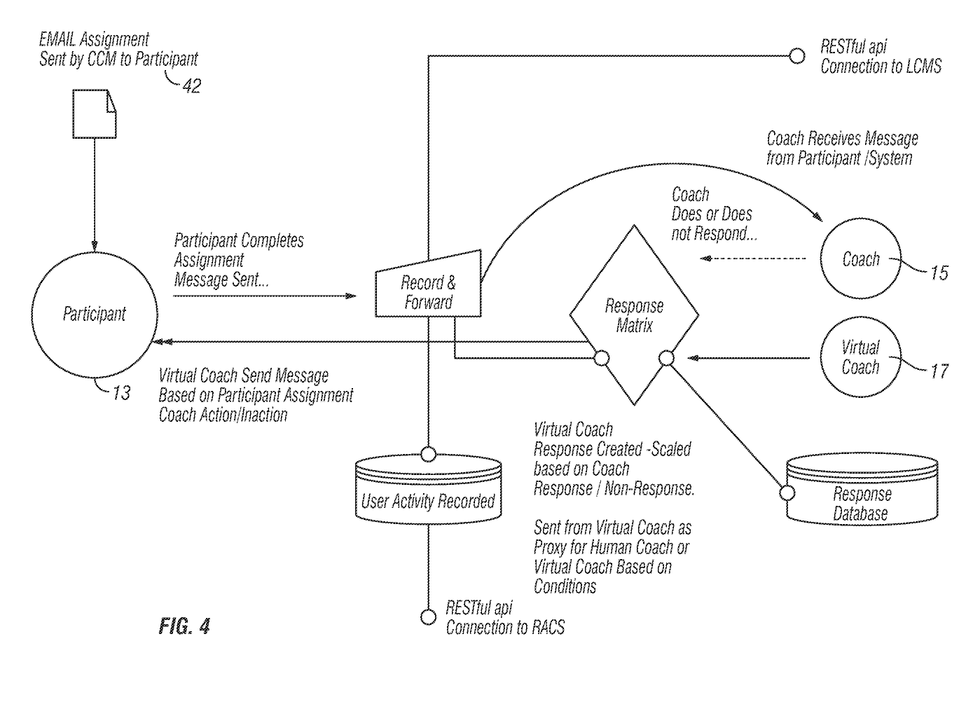

Course Message campaigns: Each assignment is announced via email 42 (see FIG. 4) and is delivered by the CCM according to course design and recipient role. This is a series of messages programmed in the Multi-Role Course Campaigns Module (CCM) for both coach and participant roles. Both roles have a unique series of personalized messages and are delivered in tandem according to the defined scheduled cadence or frequency of course assignment delivery.

The CCM has several functional modules integral to the Virtual Coach Platform.

1.) Multi-Role Course Campaigns Module: Courses are supported by at least two campaigns, one for the coaching role and one for the participant roles.
2.) Adaptive Dynamic Messaging Module: Messages sent by the CCM report back delivery status and can trigger further action by the CCM based on participant action or inaction, including but not limited to, re-sending the last message, sending the next scheduled message in advance, responding to user input to send additional instructional material and information, etc. The message construct is database driven with variable data presented to provide a personalized user experience for coaches and participants.
3.) Extended Profile Module: The list of participants and coaches for a course comprises a typical roster. To support a Collaborative Course Architecture, roster information must be extended to include the third party information to support the interaction logistics and records course campaign message delivery success and failure, i.e. status.
4.) Autoresponding Module: This is an application designed to serve as communication nexus as required by a collaborative course architecture design. The autoresponder is responsible for the delivery of course announcements, materials, assignments, assignment reminders, evaluations, and advice. The Autoresponder module acts and reacts programmatically to user (coach and participant) actions and administrator requests with changes in subscription status, message delivery, and status reports while prescriptively delivering course related communications as circumstances dictate.
5.) Broad Protocol based Messaging and Delivery Intelligence Module: CCM messages can be delivered through a variety of protocols email, SMS, and RSS. Regular SMTP email delivery is most typical.

The CCM system supports the Collaborative Course Architecture required for human and virtual coaching activities. A course is a sequence of prescribed assignments to achieve learning objectives. Typical e-learning course design anticipates the roles of an instructor or instructional agent and a participant. Collaborative course designs feature the role of a third party coach/manager. Course assignments for participants have a corresponding and complimentary assignment for the matched third party coach where an interaction between parties is an outcome required to complete the assignment. As a simple example: Participant A watches a video and is required to answer a series of questions and then speak to Coach B to discuss. During this interaction, Coach B is assigned to ask Participant A additional related questions, to discuss the answer and to collaborate on ways to apply what has been related. The directed collaboration platform for virtual coaching provides an “overlay” application for collaborative course architecture that automates human coaching and content reinforcement.

Course Message Campaign: Each assignment is announced via email and is delivered by the CCM according to course design. This is a series of messages programmed in the Multi-Role Course Campaigns Module for both coach and participant roles. Both roles have a unique series of personalized messages and are delivered in tandem according to the defined cadence of course assignment delivery.

Course Message Campaigns are outbound (sent) to participants and to human coaches and interact through Adaptive Dynamic Messaging with the Virtual Coach 17 (see FIG. 1) as activated by inbound participant or coach replies, questionnaire responses, pre-determined schedule, etc.

The Virtual Coach prompts participants and human coaches to achieve course design objectives. By design, the Virtual Coach platform scales the Virtual Coaching activity or involvement to compliment active human coaches and fully replace inactive human coaches (see FIG. 4). As a simple example: Participant A watches a video and is prompted to answer a series of multiple choice questions and submits the required answers to the Virtual Coach. The Virtual Coach immediately responds that the submissions have been received. Based on a directed cadence, the Virtual Coach then sends individualized coaching tips to Participant A and Participant A's manager. Participant A's manager has the option of providing other coaching and reinforcement. This process can be repeated with new content and all activity is captured and can be reported on.

The Virtual Coach is a set of daemons programmed to play a part in defined interactions with participants and human coaches to support the completion of course assignments and objectives. The Virtual Coach is an automated stand-in for the actual coach during prescribed interactions between participants and coaches as dictated by course design. The Virtual Coach can adopt the role of an assistant to the coach or as the system itself or both. As an assistant to the coach, the Virtual Coach can communicate under the coach's signature, taking the form of a ghost writer, essentially communicating as the coach in lieu of the coach. The Virtual Coach can also communicate independently with participants as the system and/or as an avatar of fictitious or real instructional staff. This is a variation on the common practice of using automated ‘Out of Office’ replies for example. A Virtual coach anticipates more than one possible response and does so within the context of course assignment objectives and design.

Registration Access Control (RACS) is the repository of participant and coach profile information, enrollment records, activity records, and other reports. The RACS component serves as the system user directory and interfaces with the other system components through the RESTful API. RACS supports several processes integral to Virtual Coach system administration and user management.

Registration Process: There are two procedure options for registration.
Singular registration describes the process of manually adding a single participant profile to the registration database. This data is collected by html form and may be entered by the participant (self-registration) or by a system/learning administrator.
Bulk registration is the process of adding multiple participant records to a registration database at once. An html form permits the upload of an Excel or csv formatted document to a directory where the file is parsed and inserted into the registration database.

Authentication Process: Participants are issued a specific set of credentials (username, password, URL to locate the site) and these credentials are required to access all systems. The RAGS system securely stores user credentials and profile information and permits only users who successfully enter that information to establish a session, i.e. access the system services, interfaces, and content. RACS also serves as a directory rights server, passing session approval and status to other components of the Virtual Coach for ease of use. There are different levels of access granted per user, per role, per component, etc. One set of credentials is maintained per user and authenticates the user in all components. This is referred to as single sign-on or SSO.

Reporting Process: RACS can generate and send reports and messages to participants, coaches, and system administrators containing user credentials, user activity, system activity, and general roster information. The Learning Content Management System (LCMS) is a web application compliant with all internet standards and contains dynamic course content including streaming videos, documents, HTML presentation, images, and animations. The LCMS contains applications for creating contextually relevant meeting invitations, messaging between participants and coaches and the distribution of portable documents. The LCMS records all participant and coach (users) activities in a log. The RAC generates reports based on LCMS activity logs. The component is secured and can only be accessed with valid credentials from the RACS component. User roles determine the nature and level of user access.

The following are Virtual Coach Case Examples of Complementary Scaling Virtual Coach/Human Coach Involvement and Deployment.

The Virtual Coaching user experience is a dynamic content delivery and automated course reinforcement path that changes based upon participant and coach interactions. Participants feel challenged by assignments and supported as they interact seamlessly with both live human and Virtual Coaches.

### The Example Case Instances

### Introduction

The Virtual Coach works alongside assigned human coaches to assist participants by auto-scaling involvement and direct contact with participants in a manner that complements optional human coaching activity and contact on a per assignment basis.

### Case Instances—Three Examples

Three participants are added to a course roster with extended profile information listing the designated coach for each. Participant A is paired with coach A; participant B with coach B; participant C is paired with coach C for illustration purposes. An assignment for the course is announced via email to all participants and coaches along with pairing information by the Virtual Coach.

Listed are three cases where varying levels of Virtual Coach involvement are illustrated.

In Example Case #1 (Minimal Virtual Coach Involvement; see FIG. 6): Participant A completes the participant role activities. A status update is sent to Coach A. Coach A indicates readiness to interact with the assigned participant and participant A is informed. Participant A initiates contact with coach A. A follow-up questionnaire is sent shortly after to the participant and coach. The assignment is deemed completed. At a predetermined time in the future a message containing advice and further instruction is sent to the participant by the Virtual Coach related to the topic of the assignment. In this case, the involvement of the Virtual Coach (VC) is minimal.

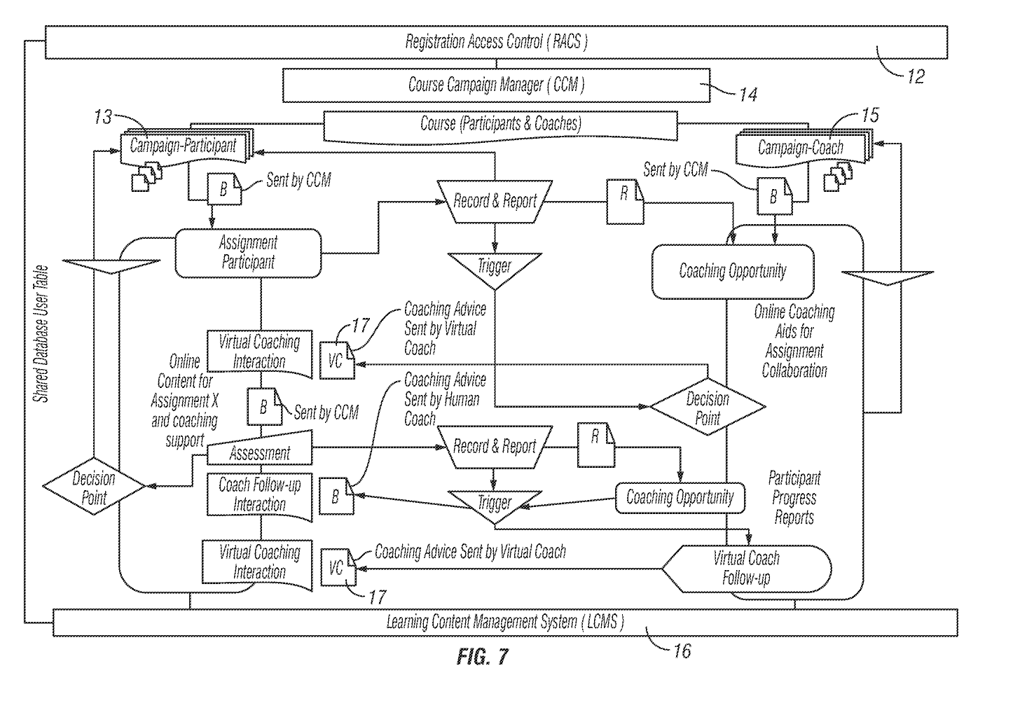

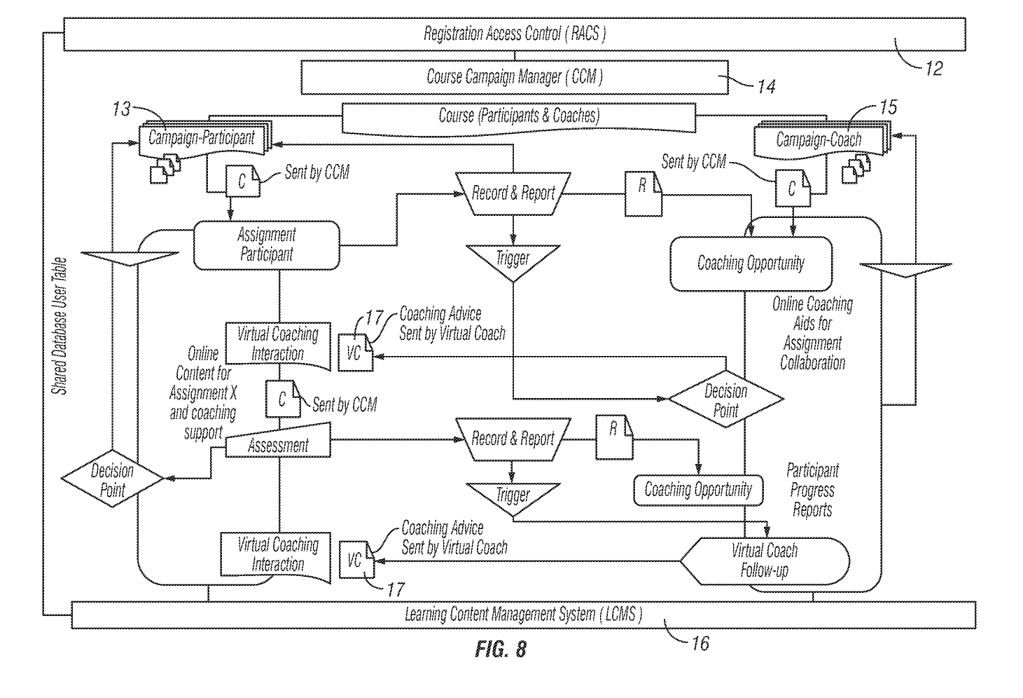

In Example Case#2 (Shared Coach Reinforcement/Human Coach and Automated Virtual Coach; see FIG. 7): Participant B completes the participant role activities for the assignment. A status update is sent to Coach B. Coach B does not indicate readiness to interact with the assigned participant. The Virtual Coach becomes active. The Virtual Coach sends participant B a message containing advice and further instruction based on the answers to the activity questions submitted by participant B. Coach B is informed via email and elects to contact participant B to further collaborate on the assignment. A follow-up questionnaire is sent shortly after to participant Band coach B. The assignment is deemed completed. At a pre-determined time in the future a message containing advice and further instruction is sent to the participant by the Virtual Coach related to the topic of the assignment. In this case, the involvement of the automated Virtual Coach is shared with the paired human coach.

In Example Case #3: (Total Virtual Coach-Driven Implementation; see FIG. 8) Participant C completes the participant role activities and submits required activities to the Virtual Coach. A status update is sent to Coach C. Coach C does not indicate readiness to interact with the assigned participant. The Virtual Coach becomes stays active. The Virtual Coach sends participant C a message containing advice, e.g. individualized coaching tips, and further instruction based on the answers to the activity questions submitted by participant C. Coach C also receives a copy of the individualized coaching tips and via email. A follow-up questionnaire is sent shortly after to the participant and coach. The assignment is deemed completed when participant C completes the questionnaire. At a pre-determined time in the future, a message containing advice and further instruction is sent to the participant by the Virtual Coach related to the topic of the assignment. In this case, the Virtual Coach is completely standing-in for the human coach.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A directed collaboration virtual coach, comprising:
a registration access control (RAGS) module comprising a repository of participant and coach profile information, enrollment records, activity records, and reports;
a course campaign manager (CCM) module, in communication with said RACS and configured to govern communication between participants, coaches, and a virtual coach, wherein said virtual coach is configured to work alongside assigned human coaches to assist participants by auto-scaling involvement and direct contact with participants to complement optional human coaching activity and contact on a per assignment basis; and
a learning content management system (LCMS), in communication with said RAGS and containing online course materials and extended participant and coach profiles, wherein said LCMS is configured to collect participant activity and to provide usage reports, said LCMS comprising a plurality of courses organized into participant campaigns and coach campaigns, wherein each campaign comprises a collection of sequenced dynamic messages, including any of announcements, assignments, advices, and course materials, and wherein a course comprises a sequence of prescribed assignments that are executed to achieve learning objectives.

2. The directed collaboration virtual coach of claim 1, wherein said CCM module is further configured to manage one or more course message campaigns, in which each assignment is announced and delivered by said CCM module according to course design and recipient role as a series of messages programmed in said CCM module for both coach and participant roles, wherein said coach and participant roles each have a unique series of personalized messages and wherein said messages are delivered in tandem according to a defined scheduled cadence or frequency of course assignment delivery.

3. The directed collaboration virtual coach of claim 1, wherein said CCM module further comprises any of:
a multi-role course campaigns module with which courses are supported by at least two campaigns, one for a coaching role and one for a participant roles;
an adaptive dynamic messaging module with which messages sent by the CCM module report back delivery status and can trigger further action by the CCM module based on participant action or inaction, said further action comprising any of re-sending a last message, sending a next scheduled message in advance, and responding to user input to send additional instructional material and information, wherein said message construction is database driven with variable data presented to provide a personalized user experience for coaches and participants;
an extended profile module comprising a list of participants and coaches for a course comprising a typical roster, wherein roster information comprises third party information for supporting interaction logistics and records course campaign message delivery success and failure;
an autoresponding module configured to serve as a communication nexus for delivery of course announcements, materials, assignments, assignment reminders, evaluations, and advice, wherein said autoresponder module acts and reacts programmatically to user (coach and participant) actions and administrator requests with changes in subscription status, message delivery, and status reports, while prescriptively delivering course related communications as circumstances dictate; and
a broad protocol based messaging and delivery intelligence module with which CCM module messages are delivered through any of a plurality of protocols.

4. The directed collaboration virtual coach of claim 1, wherein CCM module is configured to prompt participants and human coaches to achieve course design objectives by scaling activity or involvement to complement active human coaches and fully replace inactive human coaches based on a directed cadence.

5. The directed collaboration virtual coach of claim 1, wherein said CCM module is configured to provide an automated stand-in for an actual coach during prescribed interaction between participants and coaches, as dictated by course design.

6. The directed collaboration virtual coach of claim 5, wherein said automated stand-in is configurable to adopt a role of an assistant to a coach, as a coach itself, or both; wherein as an assistant to a coach, said automated stand-in communicates under the coach's signature in lieu of the coach; and wherein when communicating independently with participants said automated stand-in anticipates more than one possible response within a context of course assignment objectives and design.

7. The directed collaboration virtual coach of claim 1, wherein said RACS module is configured for any of singular registration by manually adding a single participant profile to a registration database, and bulk registration by adding multiple participant records to a registration database at once.

8. The directed collaboration virtual coach of claim 1, wherein said RACS module is configured to perform an authentication process in which participants are issued a specific set of credentials that are required to access all systems, wherein said RACS module is configured to securely store user credentials and profile information and to permit only users who successfully enter that information to establish a session, wherein said RACS module is configured to serve as a directory rights server, passing session approval and status to other components of the directed collaboration virtual coach, and wherein said RAGS module is configured to grant different levels of access per user, per role, and per component, wherein one set of credentials is maintained per user that authenticates the user in all components.

9. A computer implemented method for providing dynamic content delivery and an automated course reinforcement path that changes based upon participant interaction with both human and virtual coaches, comprising:
a processor configured for providing a virtual coach that works alongside assigned human coaches to assist participants by auto-scaling involvement and direct contact with participants in a manner that complements optional human coaching activity and contact on a per assignment basis.

10. The method of claim 9, further comprising:
providing a registration access control (RACS) module comprising a repository of participant and coach profile information, enrollment records, activity records, and reports;
providing a course campaign manager (CCM) module, in communication with said RACS and configured to govern communication between participants, coaches, and a virtual coach, wherein said virtual coach is configured to work alongside assigned human coaches to assist participants by auto-scaling involvement and direct contact with participants to complement optional human coaching activity and contact on a per assignment basis; and
providing a learning content management system (LCMS), in communication with said RACS and containing online course materials and extended participant and coach profiles, wherein said LCMS is configured to collect participant activity and to provide usage reports, said LCMS comprising a plurality of courses organized into participant campaigns and coach campaigns, wherein each campaign comprises a collection of sequenced dynamic messages, including any of announcements, assignments, advices, and course materials, and wherein a course comprises a sequence of prescribed assignments that are executed to achieve learning objectives.

11. The method of claim 10, wherein said CCM module is further configured to manage one or more course message campaigns, in which each assignment is announced and delivered by said CCM module according to course design and recipient role as a series of messages programmed in said CCM module for both coach and participant roles, wherein said coach and participant roles each have a unique series of personalized messages and wherein said messages are delivered in tandem according to a defined scheduled cadence or frequency of course assignment delivery.

12. The method of claim 10, wherein said CCM module is further configured to provide any of:
a multi-role course campaigns module with which courses are supported by at least two campaigns, one for a coaching role and one for a participant roles,
an adaptive dynamic messaging module with which messages sent by the CCM module report back delivery status and can trigger further action by the CCM module based on participant action or inaction, said further action comprising any of re-sending a last message, sending a next scheduled message in advance, and responding to user input to send additional instructional material and information, wherein said message construction is database driven with variable data presented to provide a personalized user experience for coaches and participants;
an extended profile module comprising a list of participants and coaches for a course comprising a typical roster, wherein roster information comprises third party information for supporting interaction logistics and records course campaign message delivery success and failure;
an autoresponding module configured to serve as a communication nexus for delivery of course announcements, materials, assignments, assignment reminders, evaluations, and advice, wherein said autoresponder module acts and reacts programmatically to user (coach and participant) actions and administrator requests with changes in subscription status, message delivery, and status reports, while prescriptively delivering course related communications as circumstances dictate; and
a broad protocol based messaging and delivery intelligence module with which CCM module messages are delivered through any of a plurality of protocols.

13. The method of claim 10, wherein CCM module is configured to prompt participants and human coaches to achieve course design objectives by scaling activity or involvement to complement active human coaches and fully replace inactive human coaches based on a directed cadence.

14. The method of claim 10, wherein said CCM module is configured to provide an automated stand-in for an actual coach during prescribed interaction between participants and coaches, as dictated by course design.

15. The method of claim 14, wherein said automated stand-in is configurable to adopt a role of an assistant to a coach, as a coach itself, or both; wherein as an assistant to a coach, said automated stand-in communicates under the coach's signature in lieu of the coach; and wherein when communicating independently with participants said automated stand-in anticipates more than one possible response within a context of course assignment objectives and design.

16. The method of claim 9, wherein said automated stand-in is configured to provide minimal virtual coach involvement, in which:
a participant completes participant role activities with regard to an assignment;
a status update is sent to a human coach;
said human coach indicates readiness to interact with the participant and the participant is informed of this readiness;
the participant initiates contact with the human coach;
a follow-up questionnaire is sent shortly after the contact to the participant and coach;
the assignment is deemed completed; and
at a predetermined time in the future a message containing advice and further instruction is sent to the participant by the virtual coach related to a topic of the assignment.

17. The method of claim 9, wherein said automated stand-in is configured to provide shared coach reinforcement between a human coach and an automated virtual coach, in which:
a participant completes the participant role activities for an assignment;
a status update is sent to a human coach;
said human coach does not indicate readiness to interact with the participant and said virtual coach becomes active;
said virtual coach sends a message to said participant containing advice and further instruction based on answers to activity questions submitted by the participant;
the human coach is informed and elects to contact the participant to further collaborate on the assignment;
a follow-up questionnaire is sent thereafter to the participant and to the human coach;
the assignment is deemed completed;
at a pre-determined time in the future a message containing advice and further instruction is sent to the participant by the virtual coach related to a topic of the assignment.

18. The method of claim 9, wherein said automated stand-in is configured to provide total virtual coach-driven involvement, in which:
a participant completes participant role activities and submits required activities to the virtual coach;
a status update is sent to a human coach;
the human coach does not indicate readiness to interact with the participant;
the virtual coach stays active and sends a message to the participant containing individualized coaching tips and further instruction based on answers to activity questions submitted by the participant;
the human coach also receives a copy of the individualized coaching tips;
a follow-up questionnaire is sent to the participant and the human coach;
the assignment is deemed completed when the participant completes the questionnaire; and
at a pre-determined time in the future a message containing advice and further instruction is sent to the participant by the virtual coach related to a topic of the assignment.

19. A storage medium containing program instructions which, when executed by a processor, implement a method for providing dynamic content delivery and an automated course reinforcement path that changes based upon participant interaction with both human and virtual coaches, the method providing a virtual coach that works alongside assigned human coaches to assist participants by auto-scaling involvement and direct contact with participants in a manner that complements optional human coaching activity and contact on a per assignment basis.
